(19) United States
(12) Patent Application Publication
(10) Pub. No.: US 2012/0313938 A1
(43) Pub. Date: Dec. 13, 2012

(54) Interface and Mechanism for a 3D Geometry Transformer and Translator

(76) Inventor: Sohrab Mohajerin, Pleasanton, CA (US)

(21) Appl. No.: 13/491,149

(22) Filed: Jun. 7, 2012

Related U.S. Application Data
(60) Provisional application No. 61/494,892, filed on Jun. 9, 2011.

(51) Int. Cl. G06F 3/02; G06T 17/00

(52) U.S. Cl. 345/420; 345/168

(57) ABSTRACT

The Transformer with an Interface of Built-In Geometry and Spatial Units in combination as interactive tools for control automation in motion detects and analyzes the dynamics of nodes and elements and automates a hybrid process of creating two types of equilibriums: Conforming Equilibrium automates geometry that conforms to dynamics of detected elements and nodes of a system in motion to lock into the motion, while Desired Equilibrium geometries are generated to achieve desired dynamism of the elements and nodes by controlling their dynamics. Another function of the Transformer is to attach physical or non-physical objects to nodes or elements for other purposes and operations. The Translator is a device which uses invented Interface and Transformer to translate elements and nodes or any other mathematical, geometrical, or symbolic expression into a standard geometric expression or an approximation of the expression utilizing the built-in functionalities of the Invention.

This is a Non-Provisional Utility Patent Application Claiming the Benefit of the USPTO Provisional Application Number: 61494892 filed on June-09-2011

### INTRODUCTIONS

### On the Subject of Order and Disorder

The Theoretical background of the invention might go back to prehistoric times when man discovered the idea of “arrangement”. The word arrangement might have different values for instance: organization/distribution, grouping/dividing, packaging/un-packing, allocation/dis-allocation, composition/decomposition, assignment/dismissal, convergence/dispersion, progression/return, array/disarray, harmony/discord, pattern/deformity, contraction/expansion, addition/subtraction, exclusion/inclusion, agreement/disagreement, formula/exception, flush/rough, rhythm/irregularity, integral/independent, bond/dissociation, connect/disconnect, consistent/inconsistent, precedence/subordination, manifest/doohickey, cheap/expensive, and comedy/tragedy.

On the latter values of Comedy/Tragedy, we have many profound comments from Writers as well as Scientist and that is why it is not restricted to literally works; In other words a Scientist might see a science in the form of Tragedy or Comedy. And we know that all scientists have experienced these values at one time or another. If we put Drama somewhere between Comedy and Tragedy that is if we are willing to define it that way for the sake of our argument, then the Invention at a perfect state is the perfect mean between the two values of Comedy and Tragedy which we call Drama. And that is as close as we might get to the Reality or Definition of the Invention in common vocabulary, at least as far as current scientific level or capability allows us to define it.

Further, it might be considered that the current technological level is the result of advances in computational sciences mainly processing of data combined with artificial intelligence (robotics and automation) and detection/control. Although all these sciences are relatively new from a practical point of view, meaning that to a large degree, seriously complex scientific obstacles and limitations still exist, from a theoretical point of view the ideas relative to the invention are very old and simple in nature and have been a good source of inspiration for the invention.

From early on those who wanted to understand underlying mechanisms in physics of natural phenomenon had to simplify it to lower levels until they could describe units responsible for the higher levels. That meant the birth of mathematical sciences. Numbers, Geometry, and their Relations were naturally the most plausible start. Then the scientists and philosophers got interested in how things correlate in nature. They also noticed inverse process never occurs in nature but it does happen in math. The cycle process on the contrary happens both in math and nature. So attention was focused on cycle.

Astronomy therefore was developed along with math at the earliest. Some historians, Archeologists and philosophers would like to think Astronomy was developed because man wanted to know more about time, navigation, religious rites, etc. but a better explanation is nature itself. Man wanted to use the universe above as a perfect lab for understanding movement in time and space.

Further, although the space designated for astronomical science was three dimensional the space was defined in two dimensions in the beginning by astronomers. They did not care so much about the three dimensionality of space. Also, it is childish to think they were not aware of the three dimensionality of space.

This is the important point why: if you understand the two dimensional, understanding three dimensional is only a matter of perception of space and time. Therefore this simplification is key to scientific or theoretical method.

### On the Subject of Theoretical Estimation

Once the simplification “rule” was established among scientists as a given, we see a development towards that approach in Greek philosophy by the likes of Pythagoras, Plato, and Democritus. We still use and follow their logic whenever we want to approach a scientific problem. Therefore the idea of Theoretical Estimation has a broad meaning. It can be as simple as gathering samples and comparing or categorizing them, to creating complex algorithms. Once we understand the building blocks of a process in lower levels then we can make other estimations for higher levels. The Art or Science of Theoretical Estimation is therefore to connect the lowest level to highest level. The lowest level and highest level however are always a limit where their definition is dependent on the technological capability in both directions. If technology allows that possibility, then the cycle is complete. If not then the cycle is diminished to only a “phase”. That is why it is called “Estimation” instead of Application. A good example is CERN.

As mentioned before, even if we use a two dimensional cross section of a phase or cycle this two-dimensionality might fall out of our limits! It could be billions of light years away or it could be two hundred miles away. Nevertheless, this is just to show how dependent Estimation is on Technology as opposed to theory itself. The benefit of Modern physics is that we can now have a better Estimation of our Theory philosophically!

Therefore, this invention falls more into the Theory's territory than an “optimal” Estimation boundary because of limitations on Technology. In this regard we can almost “Estimate” the limitations on technology by drawing analogies between current technologies and those of the future.

For instance we can draw parallels between current use of Wind Turbines for electricity and future technologies which will be “Quantum Turbines” in space. The obvious difference is the “Ecology”, the “Eco System” or the environment they are designed for, former on earth and latter in space. The other major difference is of course the Technology itself. Therefore without full understanding of the Ecology full development of Technology is not possible.

### Inventor's Source of Inspiration

The following Article was published on Jun. 8, 2010 on inventor's company website ufoforce.com and is accessible on the web at the following link:

http://ufoforce.com/index.php?option=com content&view=article&id=55:mofti-book-of-two-galaxies-3a&catid=54:perspectives&Itemid=79
This Article's full content is as follows:

### The Book of Two Galaxies

### By Mofti

### Chapter 3

### Definition of Elements

### This Chapter Contains Two Arguments

### First Argument

### Massive Elements

### This Argument Contains Four Articles

### First Article

### Definition of a Solid Body

Among those who follow traditional laws [of physics], a solid body consists of a limit which is divisible. So to that end, anything composed of more than two individual elements is a solid body in their view [resembling a cylinder].

Among early philosophers, a solid body is an element that has three dimensions, meaning it can be measured by length, width, and height [x, y, and z axis; sphere]. Schismatics have described a solid body in the following manner:

A solid body is a limit that has three dimensions.

And they have supposed that a solid body cannot exist without having at least eight elements; hence, four elements must be above four other elements, so that length, width, and height is possible [resembling a cube].

Ka'abi believes it is possible to arrive at a solid body with four elements in such manner that three elements are like a triangle on one surface and the fourth element in the middle of the triangle above on another surface. So the solid body looks like a pyramid with four triangular faces [a tetrahedron].

The dispute among those who follow logic is narrowed down to six categories; because the solid body in essence is either composite in action or not. The latter, meaning in sensation and truth, it acts as a unit not a composite.

If it is composite in action it is either compiler of limited set of units or compiler of unlimited units. And compiler of unlimited units is either compiler of minor units or non-compiler of minor units. And the latter is of four types.

And if it is not composite in action, either possible divisions are limited, or unlimited. And this is of two types. In total there are six disputes or schools of thought:

1—The standard of Orators and some early philosophers who describe the solid body complied of limited indivisible units or parts.

2—The standard of system analysts (later adopted by schismatics) who describe the solid body compiled of unlimited indivisible units or parts.

3—The standard of Democritus who described the solid body complied of minor units (atoms); since he believed that the intrinsic nature of solid body is compiled of minor units being minor cannot afford further division.

4—The standard of some earlier philosophers who thought the intrinsic nature of solid body is compiled of lines, and that is non-compiler of minor units.

5—The standard of Shahrestani which is similar to that of philosophers in the idea that solid body is compound of identity (order) and matter (chaos).

6—The standard of a group of recent platonic philosophers who deny the existence of indivisible minor unit.

### Second Article:

### Definition of Indivisible Minor Unit

Indivisible minor unit is a limited entity that cannot be divided any further, neither through separation or cuts, nor imagination or assumption. It is also referred to as the outstanding element.

However, there is dispute over its existence; Orators and a group of earlier philosophers believe that its existence is permanent. Platonic philosophers deny its existence.

The Orators speak the truth.

### Analogy

If we create a perfect sphere on a flat surface, where they meet that point on the sphere is indivisible. If it was divisible then there should be a straight line on the sphere's surface aligned with the flat surface. So it requires the sphere to have sides and this is a fallacy. And if where they meet is indivisible the result is the found minor unit, and if we turned the sphere on the flat surface still the same result is obtained. following—the final touching or contact point and the last minor unit and in this manner until the circumference is complete and the resulting circle in presence of the sphere needs to combine such a circle of indivisible minor units. And if the line consists of indivisible minor units then the result is a compound surface of lines and a solid body of surfaces, and must combine all the indivisible minor units.

### Opposing Views of Platonic Philosophers

If we put an element between two other elements so it is possible that it ends up in the mid-section of those elements with two sides the Right and the Left. So the right side from the mid-section is exactly the same distance as the left side is, and this would make the left equal to the right, but right is not equal to left so it is impossible for them to be truly the same. So now that the right side is not the same as the left side, and that requires division of minor unit which is indivisible, this is the correct argument.

### Answer

Why not allow it (the element) to speak a single intrinsic nature and do allow both identities to exist as incident?

And this argument denies the minor unit which is indivisible; so they argue the solid body becomes a solid body finally at its surface. And they argue its surface to be incident to it which yields identity.

### Third Article

### Definition of Matter (Chaos)

Matter is the territory where the element takes its shape. And Matter has four types: First Matter, Second Matter, Third Matter, and Fourth Matter.

First Matter is an element which is where identity coincident to intrinsic nature of that element exists. And intent on this element is something other than solid body.

Second Matter is a solid body that the identities of solid bodies rise to it in proportion to identity types of those solid bodies.

Third Matter is a solid body that combined with its own identity type is the territory for another identity to take shape as the relationship between wood and chair or ground [mud] to vessel [pottery].

Fourth Matter is a solid body that with these two types of identities is the territory for another identity as the relationship between body parts and the body or the parts of a building and a building.

And the First Matter is the minor unit of solid body and Second Matter the solid body's ego (self) and third and Forth Matters are minor solid body units.

There is dispute over the First Matter's existence. Platonic philosophers who deny indivisible minor unit's existence argue that the first Matter is permanent in existence. Orators and some earlier philosophers who favor existence of indivisible minor unit argue that First Matter does not exist; and this is the truth.

### Fourth Article

### Definition of Identity Types

Identity type is a real time situated element which is initiator to expressions of type. It may be interpreted that identity type occurs when different solid bodies accept variations and their results. Some are Hot, some cold, some dry, and some wet, and some accept something lower than the latter types. The earth for instance does not accept the traits of the skies and vice versa and the same with other solid bodies. And if there is meaning in various types of solid bodies it is necessary that they have difference in meaning as well, otherwise there needs to be likelihood without likelihood. And such meanings do not allow variations otherwise there needs to be other meanings and a chain reaction which might lead to the elements. And such elements are different from solid body's identity and this is common in all solid bodies and this does not provide specialties out of variations. What is discovered in solid bodies is that elements are the special expression initiators and that is the identity type. And this is what could be said of it.

And concerning this idea if there is a difference in identity types of solid bodies then it is necessary that they differ in other identities otherwise there needs to be likelihood without likelihood as mentioned above and the chain reaction, etc.

### BRIEF DESCRIPTION OF THE INVENTION

The Invention consists of two main parts: The Interface and The System or Mechanism. The Interface itself can be used for two main purposes:

1—As a standalone Modeling for CAD/CAM Interface: The Interface has built-in, smart, Environment (Eco System) Driven geometries described in drawings in FIGS. 1—, Which makes it different in that respect from existing conventional Cad /Cam software interfaces like Dassault Systems Catia or Solidworks and 3d rendering and animation software like Autodesk's 3d studio max and Maya or any other mainstream Cad/Rendering program like AutoCAD or Rhino.

What is meant by built-in is that the geometries are not user-created; instead they are already built-in and accessible through the special key-pad designed for the purpose. Further, these geometries are Smart meaning they are able to Nest, Add, Subtract, Divide, Multiply; Morph, Generate, Simulate, and Create Smart Wireframes,etc. within the 3d environment on command or automatically within set tolerances and parameters, and are not Random; commands may vary from simple nodes or points of reference to complex sensor driven simulation in Specified Environments (Eco Systems).

These features are non-existent in current Cad/Cam and modeling software and as opposed to regular 3d animation software used for movies or gaming environments where geometries are created by random generation or created by programmed variations for those particular effects the Smart geometries follow a completely different logic of determining a suitable solution for a problem and are not programmed like effects or random simulations of geometries or shapes for instance fractals, falling rain, or flying birds. Therefore Conventional programs whether for Modeling and Design or 3d animation do not have these features and do not follow this logic.

2—As an Interface for the Mechanism: As mentioned above the commands using the interface can be sensor driven and can simulate geometries. If we reverse the process by using the interface as a sensor system that creates geometries and adjusts them to form other geometries through a smart manipulation of the geometries and hence automatically generating command and control as for instance in robotics, then we have a second type of use or the Interface for the Mechanism.

### The Mechanism:

Although the Mechanism is rather simple in concept and design, which basically resembles a robot with sensors, the idea of “What the Mechanism does and how it does it” is the more complex and challenging part.

The Mechanism consists of a frame unit, a filter interface unit with sensors and detection system unit, processing and analysis unit, plus a command and control unit.

To simplify the Interface and Transformer concepts into very basic ideas we can imagine the idea or inspiration source of a Lego set where blocks are attached to each other combined with the utilization of geometry and economy of Origami, adding to them smart detection, automation, and control with the possibility of creating equilibriums. And the Translator concept is basically a barcode inspired concept taken to the realm of artificial intelligence.

### Interface and Mechanism for Transformer and Translator

### Full Description

My invention consists of two parts: 1—The Interface. 2—The Mechanism and its symbolic representation through the described Interface.

### 1—The Interface:

The interface itself has at least two modes, functions or possibilities of use: A—As a Stand-alone Interface for three dimensional space for instance a CAD/CAM program, a 3d application, or a packaging software where a modular Interface is necessary for easy manipulation and viewing of 3d objects. B—As an Interface for the Mechanism.

### A—The Stand-Alone Interface

The interface consists of three parts: 1—Control or Key Pad; 2—Graphic Representation; 3—The built-in function

### 1—Control or Key Pad:

The Control or Key pad has the following functions and attributes and by pressing on the key pad or control the interface responds in the same manner using a keyboard for a CAD or 3d program. Either the Special Key Pad or a Control functioning like the Key Pad or a computer keyboard can be used to operate within the interface environment for prompting the commands:

a—Number (0) represents and prompts Circle-1 and the Disc.

b—Ctrl+number (0) represents and prompts Circle-2 in the Disc.

c—Number (1) represents and prompts the Sphere.

d—Number (2) represents and prompts the Cylinder.

e—Number (4) represents and prompts the Tetrahedron.

f—Number (8) represents and prompts the Cube.

g—Number (6) represents and prompts the Octahedron.

h—Number (3) represents and prompts an input for a regular polygon mesh on a selected face or 2d element that has at least 3 points in the 3d space.

i—Ctrl+number (3) represents and prompts an input for any other type of polygon mesh that is not regular, where the user can choose from categorized pool of stored information like a Tool box, and can decide to either position the center point or any other pre-programmed geometric element on a selected surface or an axis on a surface or any 2d element which has at least two points on a surface.

j—Number (5) represents and prompts an input for a regular polyhedron positioning its center point on a selected point or axis or any 2d element which has at least one point.

k—Ctrl+number (5) represents and prompt an input for any other type of polyhedron that is not regular where the user can choose from categorized pool of stored information like a Tool box, and can decide to either position the center point or any other pre-programmed geometric element on a selected point or axis or any 2d element which has at least one point.

I—Number (7) represents and prompts an input for a Cartesian coordinate system with an Origin, where the user can position the Origin on any 2d element that has at least one point in 3d space.

m—Cntrl+number (7) represent and prompt an input for an axis system and input for other required information to describe the coordinate system.

n—Number (9) represents and prompts a smart input for all the elements in automation.

### 2-Graphical Representation:

(i)—An origin: usually referred to the central point of reference in a 3d environment.

(ii)—A Cartesian coordinate system: The X-axis, Y-axis, and the Z-axis used in a 3d environment for positioning and spatial point of reference; or another type of axis system.

(iii)—A disc: consists of a disc with two circles; circle-1 contains a second circle-2 where circle-1 in default position has its center at the origin, but can be positioned anywhere in the 3d space and can rotate on any default axis or any defined axis in 3d space, and the circle-2 has the same properties as the circle-1 and in addition to those properties described it can be concentric or non-concentric, coincident to a point on circle-1 or non-coincident to circle-1 in the 3d space.

(iv)—A sphere: in default position has its center at the origin and consists of a sphere body and three discs like the one described above inside the sphere. In default position the sphere has the same radius as the disc; each disc's center point by default is positioned on the center of sphere and each disc lies on one of three main planes of (X-Y), (X-Z), and (Y-Z) and all discs have the same properties as the disc mentioned at section (iii).

(v)—A cone: in default position has its vertex on the origin and its vertical axis is coincident to the Z-axis. The cone consists of a cone body and a disc with its center coincident to the center of the cone's base. The disc has the same properties as the disc mentioned at section (iii).

(vi)—A cylinder: in default position has its center at the origin and has the same radius as the disc and its center axis lies on the Z-axis. The cylinder consists of a cylinder body and three discs; two discs at each end of the cylinder lying on each end face or base of the cylinder and one at center of the cylinder at the origin. All three discs have the same properties as the disc mentioned at section (iii).

(vii)—A tetrahedron: in default position has its top vertex on the center of the top face of the cylinder and the other three vertices on the cylinder's vertical surface coincident to circle-1 with its vertical axis on the Z-axis. The tetrahedron consists of a tetrahedron body and four discs positioned on the center point of its faces the discs have the same properties as the disc mentioned at section (iii). By default there are two tetrahedrons one at each end of the cylinder. These Tetrahedrons serve as Independent and Codependent measure and scale identifiers of other volumes and elements and can be used for data output or input both virtually and methodically. A second set of Tetrahedrons, at the same position or a single Tetrahedron at the origin can be used for geometric or graphic representation.

(viii)—A cube: in default position has its center at the origin and its top face parallel to (X-Y) plane and side face parallel to (X-Z) plane and its vertices coincident to the circle-1. The cube consists of a cube body and seven discs, where six discs lie on each face and the seventh disc's center lies on the center of the cube on the origin. All seven discs have the same properties as the disc mentioned at section (iii).

(ix)—An octahedron: in default position has its center at the origin its end vertices on the Z-axis and the other four vertices on the cylinder's vertical surface coincident to circle-1.The octahedron consists of an octahedron body and nine discs. The discs' center lies at the center of the octahedron and the center of the each face. All nine discs have the same properties as the disc mentioned at section (iii)

(x)—Polygon meshes: polygon meshes are inputted by user or by a smart system suggesting a single choice or a combination of choices.

(xi)—Polyhedrons: polyhedrons are inputted by user or by a smart system suggesting a single choice or a combination of choices.

### 3—The Function:

a)—The graphical representations, or geometry units, disc and its circles, sphere, cylinder, tetrahedron, cube, octahedron, polygons (regular and other types), polyhedrons (regular and other types) can be inputted by command or automatically using a smart geometry system where initial input geometry by user is detected and analyzed. The input and other manual command or automatic operations can be controlled either using a regular keyboard and/or other devices as mentioned previously using interactive icons and a computer program created to perform this task. The user can then arrange the graphical representations in the 3d space in unlimited combinations of the mentioned elements manually or automatically through commands.

b)—These graphical representations can then be used as platforms or skeletons for further developing advanced secondary geometry in 3d space the way a cad program does by initially creating a wireframe on these platforms or skeletons and then turning them into surfaces and volumes.

c)—The graphical representations can all be manipulated by controls like a mouse, or other interactive devices or by formulas and programming to deform either symmetrically or asymmetrically a process which is generally referred to as morphing of an object in 3d environment, however they always retain their original geometrical properties as a ghost skeleton and object of built-in reference in 3d space.

d)—After final surfaces and volumes are created the graphical representations can then be hidden.

B—The Interface for the Mechanism

The Interface for the Mechanism has the same features as the Stand-Alone Interface for three dimensional spaces. The difference is that the built-in functionality of the geometric elements is controlled by a different process. In the Stand-Alone Interface the process is defined by the Application. For instance if designing an object and running an FEA analysis the software will suggest a number of better solutions to the geometry using the Stand-Alone interface. In the Mechanism the process is defined by the Cycle of Equilibriums which is explained below.

The Mechanism and its symbolic representation through the described Interface Technical, Practical, and Advanced Applications of the Invention

The mechanism here is described symbolically through the Interface, but the actual mechanisms can vary structurally both in size and the way they operate from Nano-scale size of a Nano-mechanism to the size of a global satellite system or a freeway system. The Mechanism also has at least two functional modes and at least two corresponding graphical representation modes:

### A—Functioning as a Smart Transformer

### B—Functioning as a Smart Translator

### A—Function of Smart Transformer

The Smart Transformer as the title suggests is a device that transforms one type of geometry to another type of geometry where the initial geometry of nodes or elements in a dynamic fluid system as the dynamic input is detected and analyzed by a smart system then processed and then a new geometry is produced in the form of polyhedron (in three dimensional space) or polygon mesh (in two dimensional space) or a combination of two in a hybrid state where the edges of the polyhedron or the polygon mesh of the output geometry lie in equilibrium between those nodes and elements of the input geometry.

As a result if the input meaning the dynamic fluid system constantly changes its dynamics so does the output change dynamically in equilibrium and this creates motion which can be used for other mechanical or non-mechanical applications. This is called the Second Equilibrium.

The second possibility is that if the process is reversed; meaning that if the smart system is programmed to react differently after the first output is created that is to create a desired equilibrium instead of a conforming one and is able to adjust the nodes and elements through smart manipulation of those nodes and elements in a dynamic fluid system it creates a Reverse Equilibrium which can be used for example in information technology and other computing technologies (for instance cloud computing). This is called the First Equilibrium.

The third possibility is that if the outputs themselves are used as smart devices meaning that if they can transfer complex information via smart technologies embedded in certain devices where that information becomes readily available and processed but ordinary devices cannot operate as efficiently to detect the dynamics as input or create a responsive solution for stimulus or operation as output, for instance as Nano-mechanisms in the field of medicine for blood and organs, or as a replacement for chemotherapy and radiation in cancer treatment.

### B—Function of Smart Translator

The Smart translator as the title suggests is a device that translates one type of expression to another type of expression. These Expressions can be Mathematical, Geometrical, and/or Vocal (Symbolic).

Geometrical to Mathematical, Vocal (voicing, symbolization), visual and vice. versa:

This device can take geometry input as code and translate it into output both in the form of new geometry ,or an expression and vice versa. The input geometry is first projected, created, or automated, then translated by the smart system, projected as output like a new geometry, or an expression. The expression is the word used to describe either a defined or undefined form. A defined form is a standard of expression defined by the user.

The undefined form is an approximation of the expression where no standard exists but the system using smart technologies provides an approximation to a standard of expression. For instance in Chinese languages there are different ways to pronounce a word which make the meaning different. Each instance is a standard of expression. But if the word is somehow pronounced differently which is undefined it is projected as an approximation. Same could be said about colors. There are many variations of the color Blue which the user can define as for instance sky blue, cobalt blue, navy blue etc., but if there is a color that does not fit any of those defined expressions it is considered an approximation.

The flow chart in FIG. 21 shows how the mechanism or the system of equilibriums works and in FIG. 14-FIG. 17 we can see how equilibrium is created in two dimensional or near “flat space” and in FIG. 18-FIG. 20 we can see how equilibrium is created in three dimensional space. This is a basic example of its functionality where equilibriums of elements are created after detection through analyzed motion in a cycle.

### ADVANTAGES OF THE INVENTION

### The Interface:

The Built-In functionalities of the interface along with the way geometry and automation is used to facilitate and solve current problems with CAD /CAM is unique in this invention specially the underlying logic of determining the make-up of spatial geometry in 2d or 3d space by pre-made geometry tools and the way they interact, instead of leaving everything to the user. This way a huge load is taken off on assessing and planning a design.

As for the interface used in the transformer and translator—again it is unique in a sense that the visualization aspect combined with easy functionality of the interface allows user to have complete control over the subject and hence on the operations.

### The Transformer:

The Transformer is versatile in the sense that it can operate both as a conforming and desired equilibrium creator and in truth it is a hybrid system with dual functionality while a third functionality of control over nodes and elements is added to make it the ultimate modern tool for detection, filtering, automation, design, and operation.

The Translator:

The Translator is also unique not only for solving approximation problems but creating a new standard in coding objects.

### DRAWING DESCRIPTION

FIG. 1—Isometric drawing of the Disc

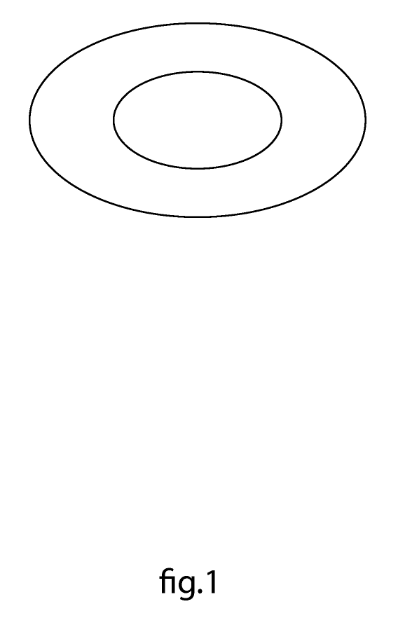

FIG. 2—Isometric drawing of the cone

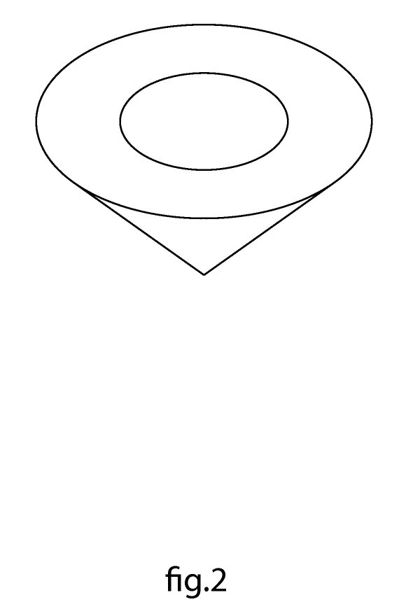

FIG. 3—Isometric drawing of the sphere

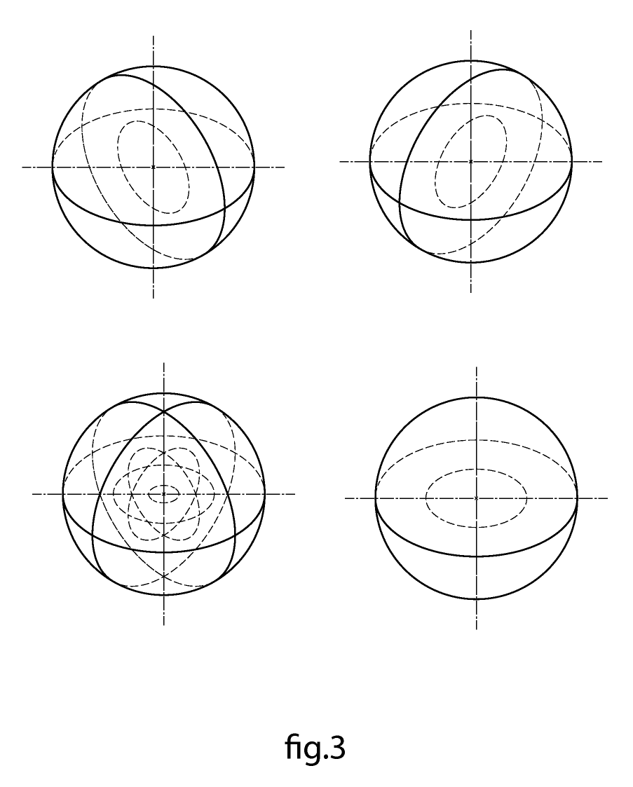

FIG. 4—Isometric drawing of the cylinder

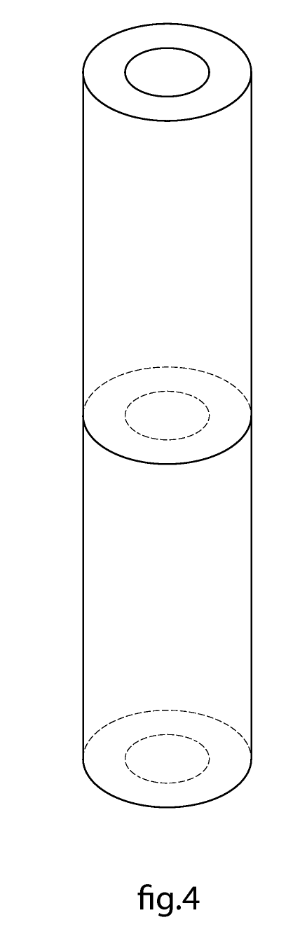

FIG. 5—Isometric drawing of the tetrahedron

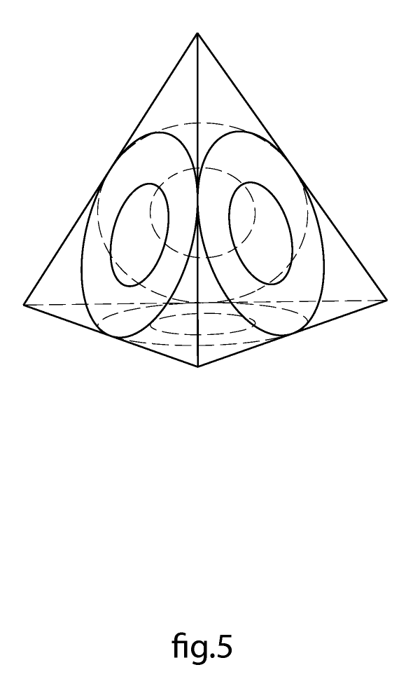

FIG. 6—Isometric drawing of the octahedron

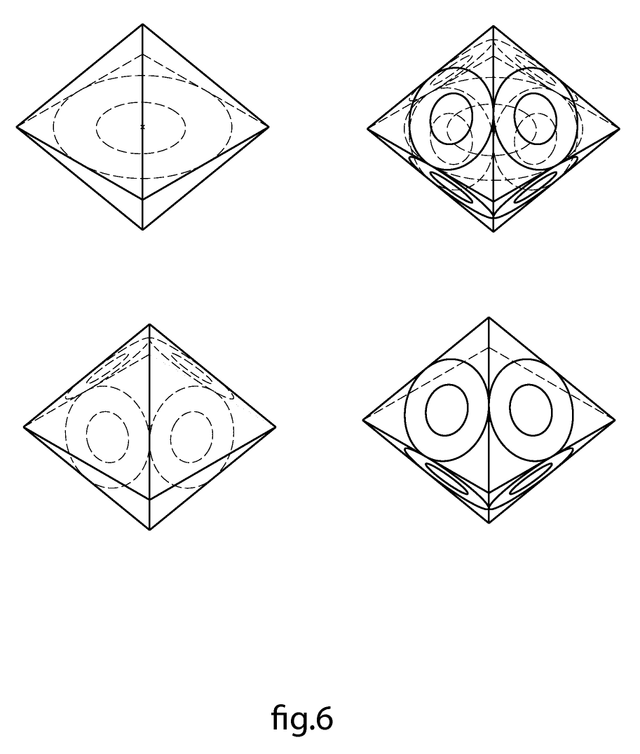

FIG. 7—Isometric drawing of the cube

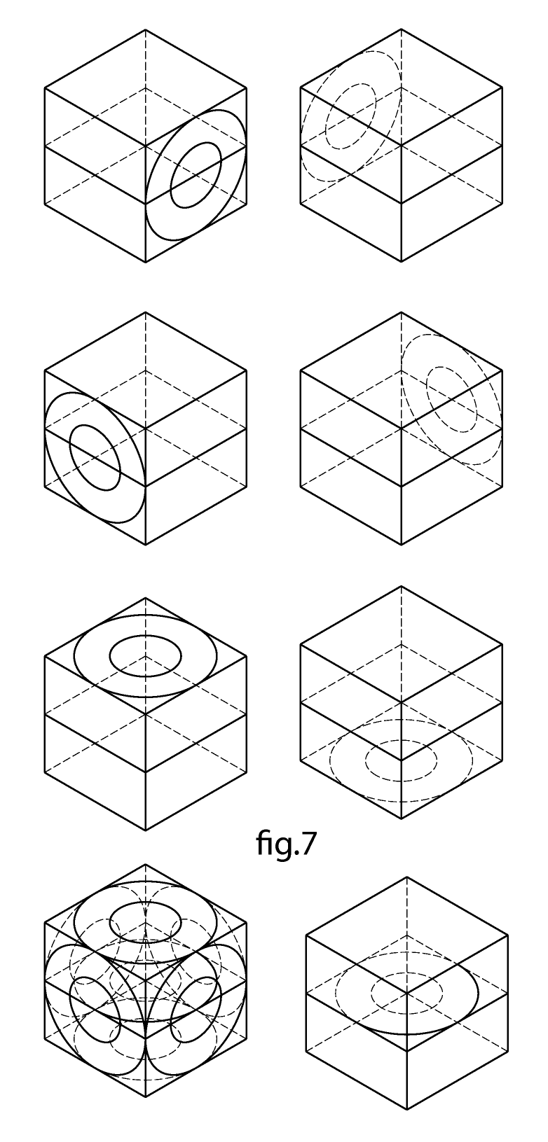

FIG. 8—Isometric drawing of the cone in default configuration

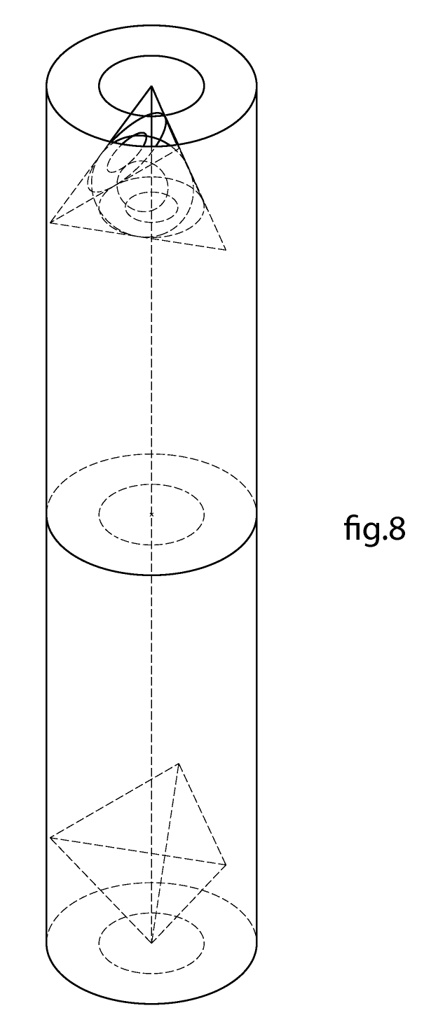

FIG. 9—Isometric drawing of the sphere in default configuration

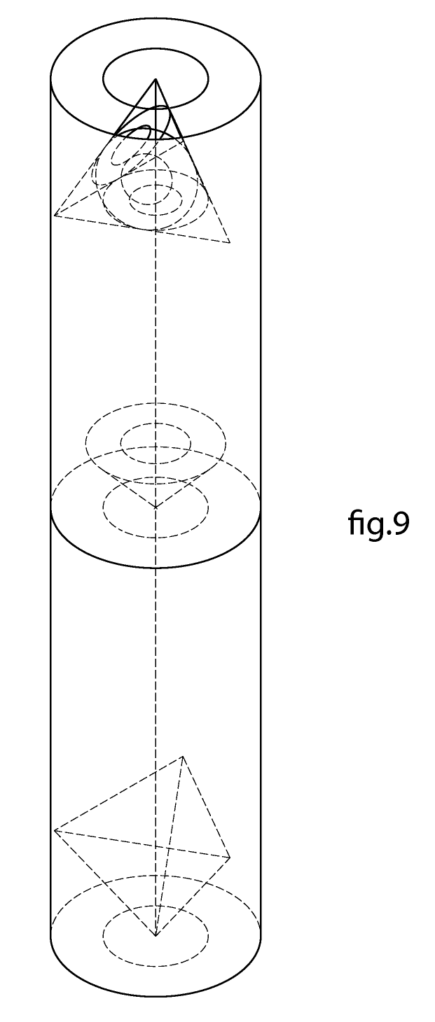

FIG. 10—Isometric drawing of the octahedron in default configuration

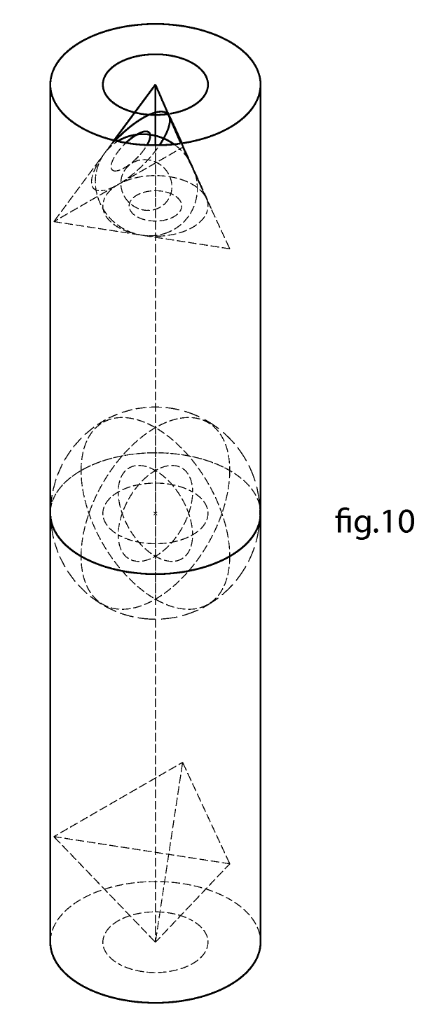

FIG. 11—Isometric drawing of the cube in default configuration

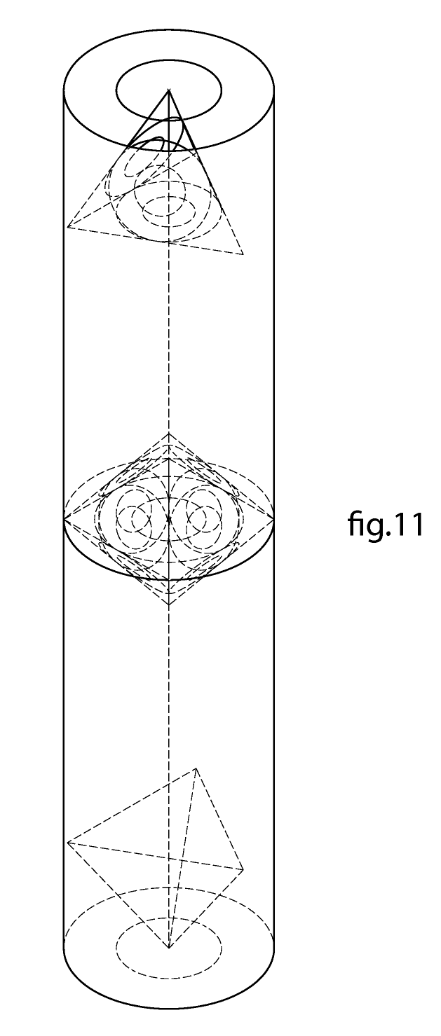

FIG. 12—drawing of keypad

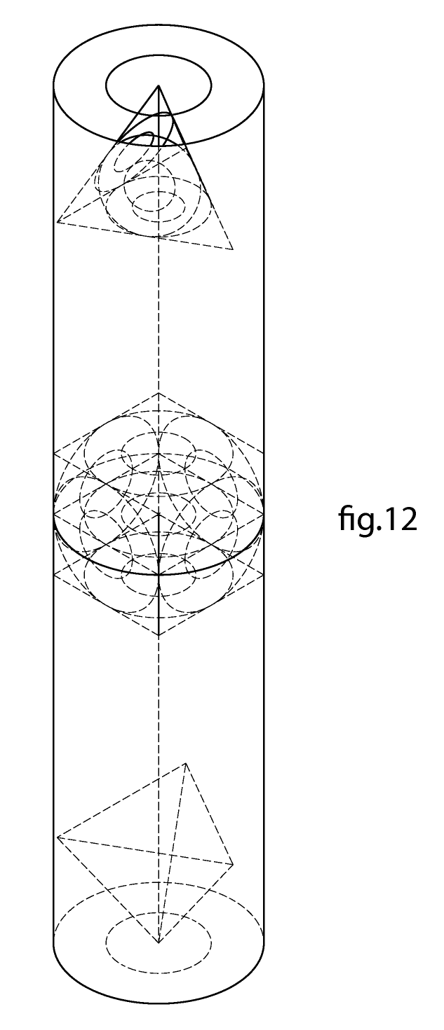

FIG. 13—Isometric drawing of the polygon on disc

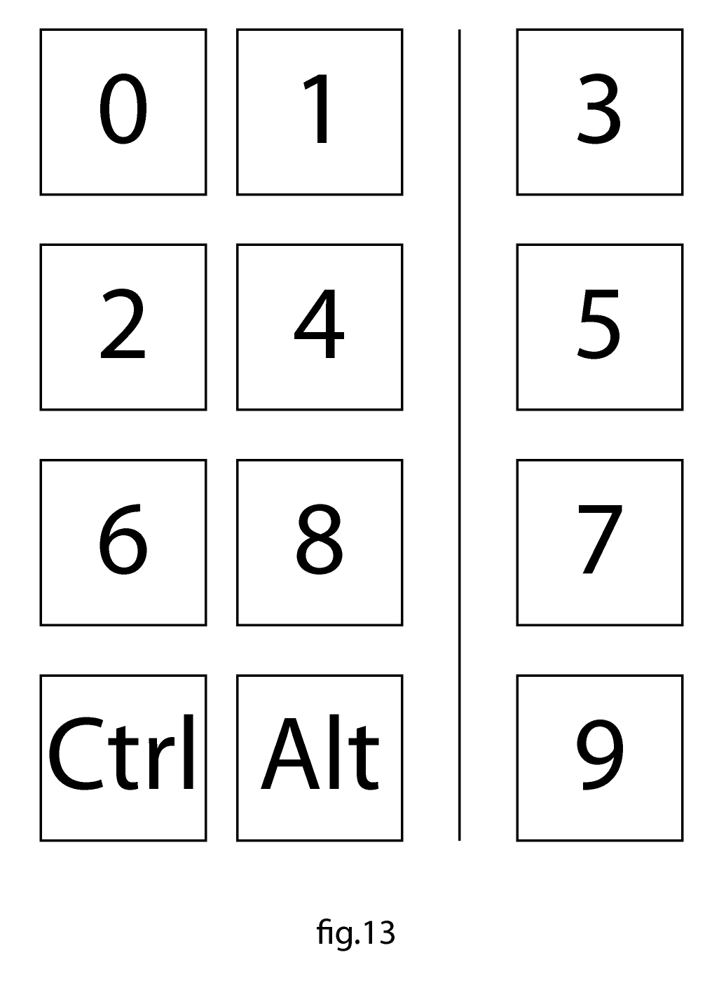

FIG. 14—drawing of polygon mesh with elements

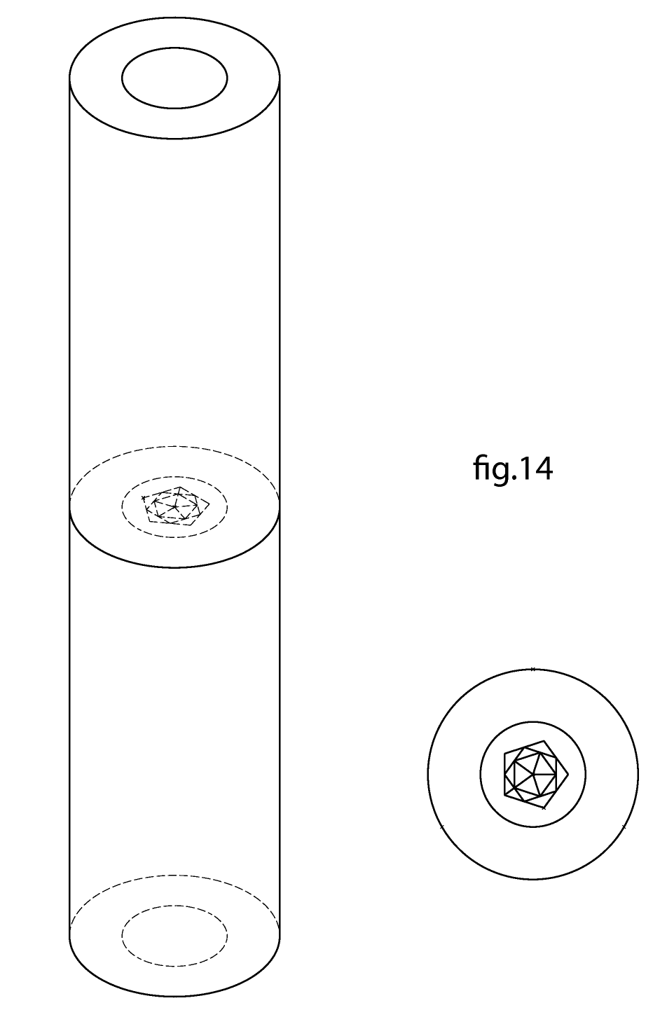

FIG. 15—drawing of polygon mesh with elements in first equilibrium which is called conforming

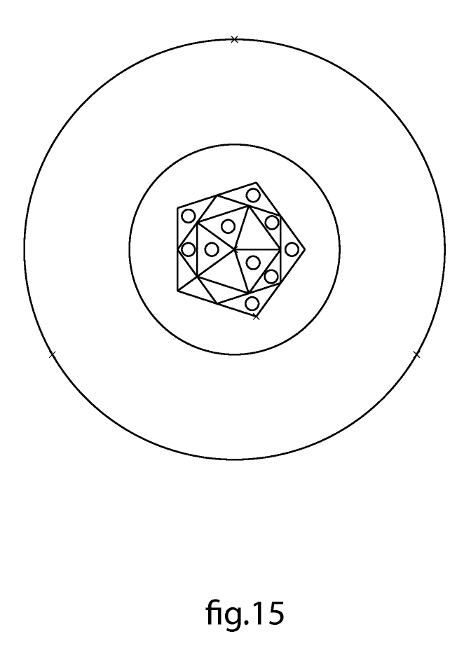

FIG. 16—drawing of polygon mesh with elements not in equilibrium

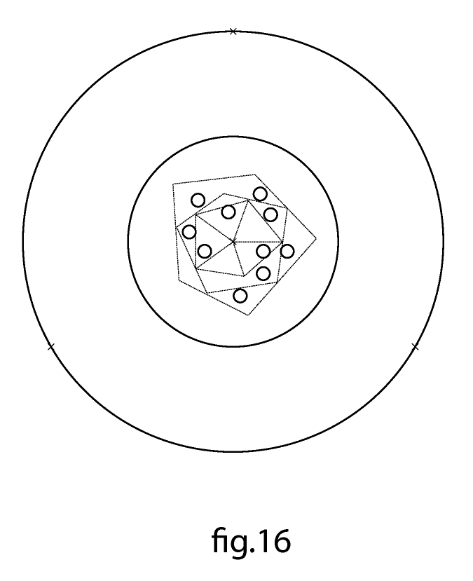

FIG. 17—drawing of polygon mesh with elements in second equilibrium which is called desired

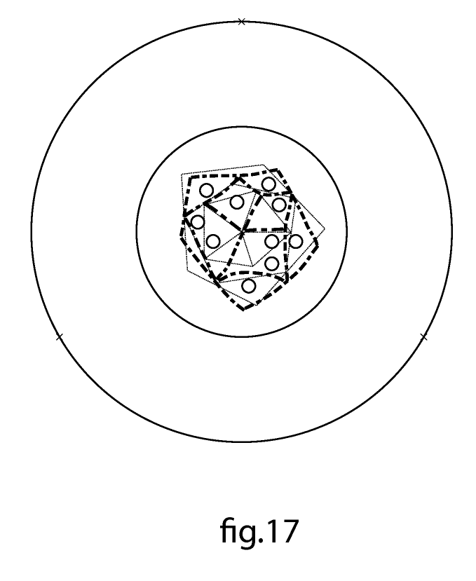

FIG. 18—Isometric drawing of the polyhedron mesh in first equilibrium with elements on disc which is called conforming

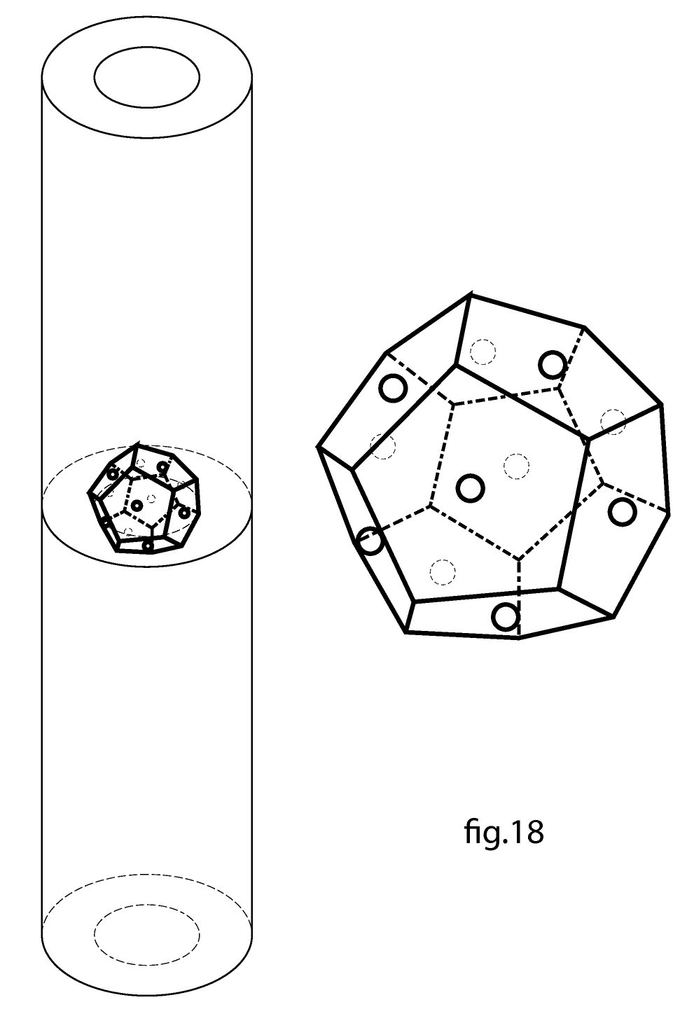

FIG. 19—Isometric drawing of the polyhedron with elements not in equilibrium

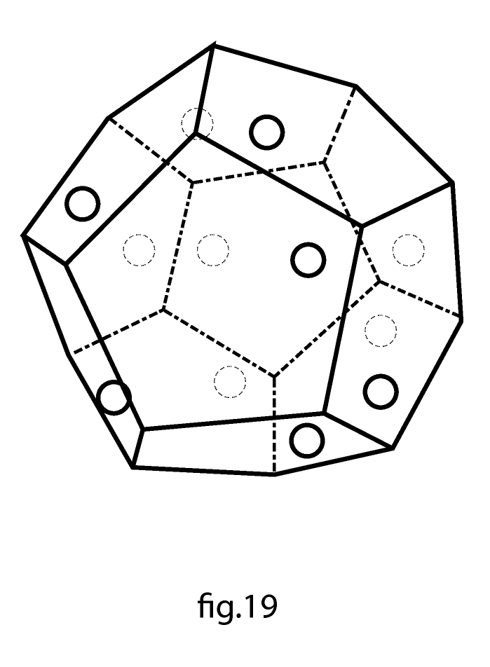

FIG. 20—Isometric drawing of the pblyhedron with elements in second equilibrium which is called desired

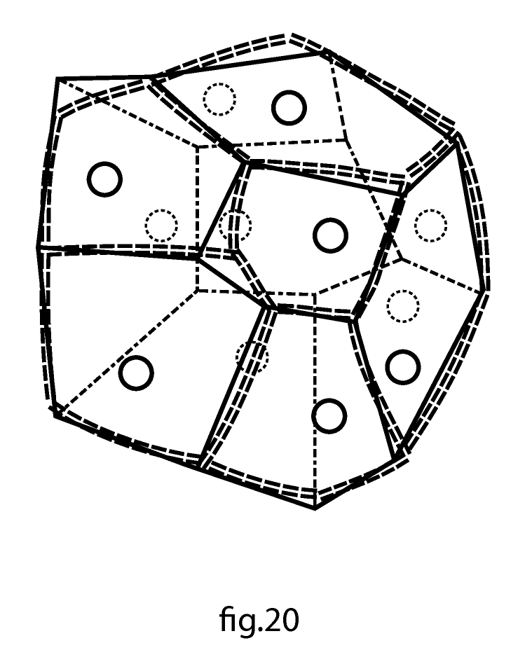

FIG. 21—Flow chart for first and second equilibriums.

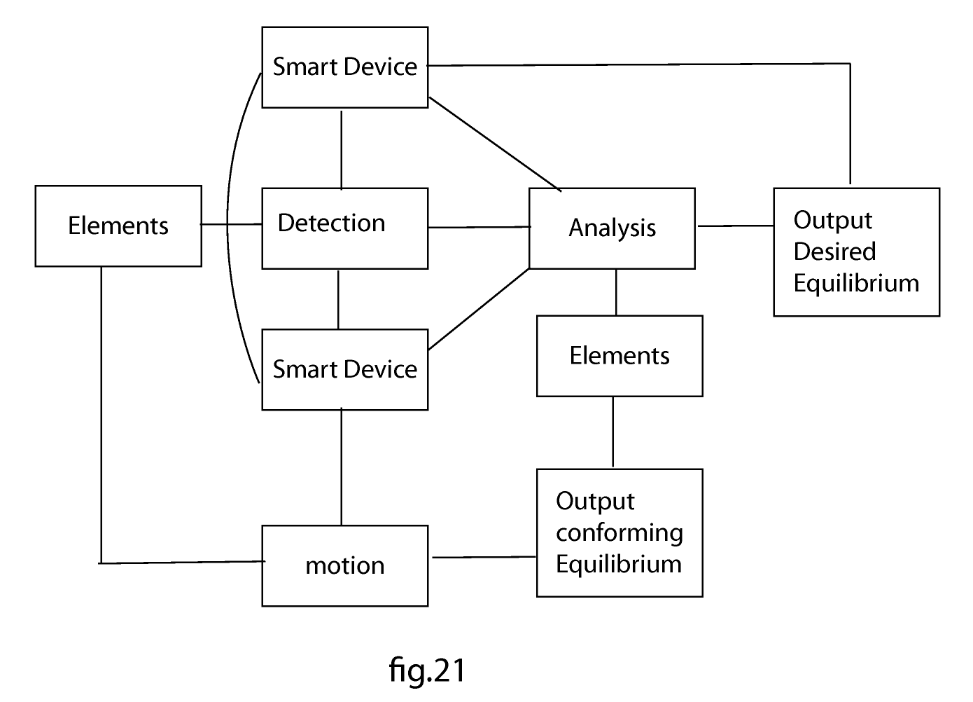

What is claimed is:

1- An Automated Interface article used in a three dimensional or two dimensional virtual environment of a computer or any other electronic device with an Interface capability comprising the following Smart Built-In Geometry Units and Functions in Spatial Units of either Cartesian Coordinate or other Axis System settings:
Spatial Units: An Origin Unit containing a single point; Cartesian Coordinate System Unit; Axis System Unit; Geometry Units: A Disc Unit:
consists of a circular disc outline or space containing two circles: Circle-1 and Circle-2; A Sphere Unit utilizing 3 disc units by default; A Cone Unit utilizing 1 disc unit by default; A Cylinder Unit utilizing 3 disc units by default; A Tetrahedron Unit utilizing 4 disc units by default; A Cube Unit utilizing 7 disc units; An Octahedron Unit utilizing nine disc units; Regular Polygon Mesh Unit; Irregular Polygon Mesh Unit; Polyhedron 3 dimensional Mesh Unit, Irregular Polyhedron 3 dimensional Mesh Unit.

2. A Keypad Design associated with article of claim 1 consisting of 12 keys arranged in 3 columns and 4 rows, where 2 of the columns on the left side of keypad are separated by a partition line or separator from the last column on the right side of the keypad by default; The first column from the left side of the keypad contains from top to bottom the numbered keys 0,2,6 and lettered key Cntrl respectively; the second column from left contains from top to bottom numbered keys 1,4,8, and lettered key Alt respectively; the third column from left contains from top to bottom numbered keys 3,5,7, and 9 respectively; the rows and columns can be arranged or programmed differently on a digital USB touch screen keypad/device hybrid by the user in any combination of rows and columns.

3. A Process associated with article of claim 2 describing the functions of the keys on the keypad is as follows: Number (0) key on the keypad represents and prompts the Disc Unit and Circle-1 in claim 1; Cntrl+Number (0) keys on the keypad represents and prompts the Circle-2 in claim 1; Number (1) key on the keypad represents and prompts the Sphere Unit in claim 1; Number (2) key on the keypad represents and prompts the Cylinder Unit in claim 1; Number (4) key on the keypad represents and prompts the Tetrahedron Unit in claim 1; Number (8) key keypad represents and prompts the Cube Unit in claim 1; Number (6) key on the keypad represents and prompts the Octahedron Unit in claim 1; Number (3) key on the keypad represents and prompts an input for a Regular Polygon or Regular Polygon mesh Unit or Units in claim 1; Ctrl+Number (3) keys on the keypad represent and prompt an input for any other type of Polygon Unit that is not regular or its Mesh Unit in claim 1; Number (5) key on the keypad represents and prompts an input for a Regular Polyhedron Unit or its Mesh Unit in claim 1; Ctrl+Number (5) keys on the keypad represent and prompt an input for any other type of Polyhedron Unit and its Mesh Unit that is not regular Number in claim 1 (7) key on the keypad represents and prompts an input for a Cartesian coordinate system Unit in claim 1; Cntrl+Number (7) keys on the keypad represent and prompt an input for an Axis System Unit in claim 1; Number (9) represents and prompts a Smart Input for all the elements in Automation Mode in claim 1.

4. Process and Function associated with articles of claim 1-3, Utilizing the Interface as described, Input Keypad as described, Command and Control Capabilities, Smart Detection and Processing Capabilities, meaning they are able to Nest, Add, Subtract, Divide, Multiply, Morph, Generate, Simulate, and Create Smart Wireframes, Etc., Automation Capabilities, and other Related Available Technologies as follows: The Origin Unit serves as the central point of reference in the 3 dimensional environment; The Cartesian Coordinate System Unit or other Axis System Unit can be inserted; The Circle-1 inside The Disc Unit in default position has its center at the Origin Unit; Circle-1 can be positioned anywhere in Cartesian Coordinate System Unit or other Axis System Unit, can rotate on any Axis or Point; Circle-1 Dimension and position can be determined either by the user or the smart automated system; Circle-2 inside Circle-1 has the same properties as Circle-1 its dimension limit equal or smaller to Circle-2, it can be concentric or non-concentric to Circle-1, coincident tangent or non-coincident non-tangent to Circle-1; Circle-2 Dimension and position can be determined either by the user or the smart automated system; In default the Sphere and Cylinder Units have the same radius as the Disc Unit and Cone, Tetrahedron, Cube, and Octahedron Units' have Disc Units tangent to theft faces' sides ; The Disc Units inside Geometry Units function the same as the Disc Unit itself and serve as reference geometry and guides for the Geometry Units; hence Geometry Units can be manipulated by the user or the automated system to change their form using Disc Units; The Geometry Units can also be snapped on to each other using the Disc Units; The three Disc Units inside the Sphere Unit in default are positioned at center point of the Sphere Unit Perpendicular to each other; The single Disc Unit is centered at the base of the Cone Unit and perpendicular to the Cone Unit's vertical axis that goes through its vertex; In the Cylinder Unit Two Disc Units are at each end of the Cylinder Unit lying on each end face or base of the Cylinder Unit and one at center parallel to the base; The Tetrahedron Unit has four Disc Units each centered on a face of the Tetrahedron Unit; The Octahedron Unit has nine Disc Units eight centered on a face of the Octahedron Unit and one Disc Unit at the center of the Octahedron Unit perpendicular to the vertical axis going through the top and bottom vertices and tangent to sides; other Regular and Irregular Polygons have Disc Units positioned on their center tangent to sides and Polyhedrons have Disc Units centered on their faces tangent to sides and one Disc Unit at the center of the Polyhedron Units tangent to sides.

5- A Process and Function associated with Disc Unit and Geometry Units in claims 1-4: The Disc Unit can be turned into a Close Tangent Spline, a Broken or Open Tangent spline, a Regular Polygon Unit, A Polygon Unit that is not Regular, and can be dissected into smaller segments or splines; Geometry Units can be morphed by the user or the Smart Automation to new Irregular or Morphed Geometry Units.

6- A Process and Function associated with article of claim 4 as follows: all Geometry Units and Spatial Units can be inputted by command either manually, or by use of smart analysis and automation systems, where initial input by user is detected and analyzed, and solutions suggested by the system.

7- A Process and Function associated with articles of claims 4-6 as follows: The Geometry Units and spatial Units created by the user or the system can be used as platforms or skeletons for further developing advanced secondary geometry in 3d space the way a cad program does by initially creating a wirefrarne on these platforms or skeletons and then turning them into surfaces and volumes.

8- A Process and Function associated with articles of claims 4-7 as follows: Geometry Units can all be manipulated by controls, by formulas, by smart detection and automation, or by other programming to deform either symmetrically or asymmetrically a process which is generally referred to as morphing of an object in 3d environment, however they always retain their original geometrical properties as a ghost skeleton and as an object of Built-In feature in 2d and 3d space.

9- A Modified version of the Interface article in claim 1-8 with following features: the interface utilizes at least one Spatial Unit; A Cylinder Unit is placed at the center of the Spatial Unit with Its vertical axis on the Z-axis of the Cartesian Coordinate System Unit and serves as the detection environment; The Cylinder Unit can expand individually or by an Assist Multiplier Unit in all directions from fitting a portion of a Geometry Unit to large or infinite number of Geometry Units within its boundaries; two Tetrahedron Units in default position has its top vertex on the center of the top and bottom face of the Cylinder Unit respectively and the other three vertices on the Cylinder Unit's vertical surface; These Tetrahedron Units serve as Independent and Codependent measure and scale identifiers of other volumes and elements, inputted or detected, and can be used for data output or input both virtually and methodically.

10- A Function and Process of a Smart Transformer Article utilized with Interface article described in claim 8 as follows: An automated System consisting of a Smart Device in combination with a Detection Unit with Motion Analyzer and Equilibrium Analyzer which performs the following functions: Smart Transformer Transforms one type of Geometry Unit to another type of Geometry Unit where the initial geometry of nodes or elements in a dynamic fluid system as the dynamic input is detected and analyzed by a Smart Transformer system's Detection Unit in the Environment then processed by Motion and Equilibrium Analyzer to output a new Geometry Unit in the form of continuous polyhedron (in three dimensional space) or polygon mesh (in two dimensional space) or a combination of the two in a hybrid state where the edges of the polyhedron or the polygon mesh of the output geometry lie in equilibrium between those nodes and elements of the input geometry resulting in motion which can be transferred physically by material, or physical means, or mechanisms as in turbines or non-physically by non-materials, numeric ids, codes, or data as in computers for transforming purposes.

11- Function and Process of a Smart Transformer article of claim 10 as follows: A reverse process where Smart Transformer is programmed to react differently when the first output Geometry Unit is created to establish a Desired Equilibrium instead of a Conforming Equilibrium that virtually changes the position or dynamic of the nodes or elements in the given environment.

12- A Function and Process of a Smart Transformer article of claims 10 and 11 as follows: The possibility of using dynamic output nodes and elements as Smart Devices with embedded technologies to perform tasks of Detection, Analysis, and responsive output for stimulation or manipulation purposes in physical or virtual environments.

13- An automated Expression Unit article utilizing articles of claims 1-12 with following attributes: a set of mathematical, geometrical, or symbolic relations like sound or color which can be expressed in 2 dimensional or 3 dimensional space using a numeric data and code; The Expression Unit could be an already defined entity or undefined entity or form; a defined entity is a Standard of Expression defined by the user or the system; the undefined entity is regarded as an approximation of expression where no standard exists.

14- A Function and Process of a Smart Translator article utilized with articles in claim 1-13 as follows: A device that translates one type of Expression to another type of Expression using articles described in claims 1-13; The Smart Translator can take Geometry Unit input as code and translate it into output both in the form of a new Geometry Unit or various Expression Units derived from the Geometry unit by command; the Smart Analysis and Detection Unit can provide an approximation to a Standard of Expression.
